(19) United States
(12) Patent Application Publication
(10) Pub. No.: US 2012/0098496 A1
(43) Pub. Date: Apr. 26, 2012

(54) DEVICE AND METHOD FOR STABILIZING VOLTAGE OF ENERGY STORAGE

(75) Inventors: Young Hak JEONG, Gunpo-si (KR); Bae Kyun KIM, Seongnam-si (KR); Hyun Chul JUNG, Yongin-si (KR); Yong Wook KIM, Suwon-si (KR); Hee Bum LEE, Suwon-si (KR)

(73) Assignee: SAMSUNG ELECTRO-MECHANICS CO., LTD., Suwon-si (KR)

(21) Appl. No.: 13/279,603

(22) Filed: Oct. 24, 2011

(30) Foreign Application Priority Data
Oct. 25, 2010 (KR) 10-2010-0104070

(51) Int. Cl. H02J 7/00

(52) U.S. Cl. 320/122

(57) ABSTRACT

The present invention provides a device and a method for stabilizing a voltage of an energy storage capable of performing voltage stabilization in different ways by setting different references when charging or discharging and when standing by. Therefore, system resources consumed for the voltage stabilization of the energy storage can be minimized.

### CROSS-REFERENCE TO RELATED APPLICATIONS

This application claims the benefit under 35 U.S.C. Section 119 of Korean Patent Application Serial No. 10-2010-0104070, entitled “Device And Method for Stabilizing Voltage of Energy Storage”, filed on Oct. 25, 2010, which is hereby incorporated by reference in its entirety into this application.”

### BACKGROUND OF THE INVENTION

1. Field of the Invention

The present invention relates to a device and a method for stabilizing a voltage of an energy storage, and more particularly, to a device and a method for stabilizing a voltage of an energy storage capable of performing voltage stabilization by using reference voltages set differently when charge or discharge operation is performed and when charge or discharge operation is not performed, in stabilizing a voltage of a unit cell of a secondary battery or a capacitor.

2. Description of the Related Art

Stable energy supply becomes an important factor in various electronic products such as information and communication devices. In general, this function is performed by a battery. Recently, a secondary battery, which can supply energy to a device while being repeatedly charged and discharged thousands to tens of thousands of times, becomes the mainstream as a proportion of mobile devices increases.

Meanwhile, a typical secondary battery is a lithium ion secondary battery. The lithium ion secondary battery has advantages of small size, light weight, and long stable power supply due to a high energy density but has limitations such as low instant output, long charge time, and short charge and discharge lifespan of thousands of times due to a low power density.

A device referred to as an ultracapacitor or a supercapacitor, which becomes a topic recently in order to overcome the limitations of the lithium ion secondary battery, is in the spotlight as a next generation energy storage device due to a high charge and discharge speed, high stability, and environmentally friendly characteristics. The ultracapacitor or the supercapacitor has a lower energy density than the lithium ion secondary battery but has advantages of a power density tens to hundreds of times higher than the lithium ion secondary battery, charge and discharge lifespan of more than tens to thousands of times, and a high charge and discharge speed enough to be fully charged only within a few seconds.

A general supercapacitor consists of an electrode structure, a separator, an electrolyte solution, and so on. The supercapacitor is driven by an electrochemical mechanism in which power is applied to the electrode structure to selectively adsorb carrier ions in the electrolyte solution onto the electrode. At present, typical supercapacitors are an electric double layer capacitor (EDLC), a pseudocapacitor, a hybrid capacitor, and so on.

The EDLC is a supercapacitor which uses an electrode made of activated carbon and uses electric double layer charging as a reaction mechanism. The pseudocapacitor is a supercapacitor which uses transition metal oxide or conductive polymer as an electrode and uses pseudocapacitance as a reaction mechanism. And, the hybrid capacitor is a supercapacitor which has intermediate characteristics of the EDLC and the pseudocapacitor.

The above battery, secondary battery, and capacitors are used as energy storages to drive various electrical application products. However, since each cell can supply a low voltage of several volts, modularization for connecting a plurality of cells in series is essential to be used as an energy source of a device requiring a high voltage.

Further, in using the series-connected unit cells as an energy source, since a sudden reduction in lifespan of a module, damage of a device due to an overvoltage, failure of a normal operation of a device due to a low voltage may occur due to non-uniform operations of the cells, a means for controlling charge and discharge operation of the unit cells within a stable range is needed.

Meanwhile, technologies have been proposed to control stable charge and discharge of the plurality of unit cells by detecting and monitoring a voltage of each cell and cutting off power supplied to the corresponding cell when the detected voltage value is higher than a reference value.

However, conventional voltage stabilization technologies perform voltage stabilization by using the same reference and method when charging or discharging is performed and when charging or discharging is not performed. Although relatively precise control is needed for stable operation of the unit cells during charging or discharging, since the same reference is applied when charging or discharging is not performed, there is a problem such as a reduction in efficiency of a system due to unnecessary consumption of system resources for controlling voltage stabilization.

### SUMMARY OF THE INVENTION

The present invention has been invented in order to overcome the above-described problems and it is, therefore, an object of the present invention to provide a device and a method for stabilizing a voltage of an energy storage including a supercapacitor capable of performing voltage stabilization in different ways by setting different references when charging or discharging and when standing by.

In accordance with one aspect of the present invention to achieve the object, there is provided a device for stabilizing a voltage of an energy storage formed by connecting a plurality of unit cells in series including: a bypass unit connected to the unit cell in parallel; and a control unit connected to the unit cell in parallel to monitor a voltage of the unit cell and connected to the bypass unit to control on/off of the bypass unit, wherein the control unit controls the on/off of the bypass unit in two modes by determining whether the unit cell is being charged or discharged using the monitored voltage of the unit cell and applying two differently set reference voltages.

At this time, the two modes may include a first stabilization mode corresponding to a case that the unit cell is being charged or discharged and a second stabilization mode corresponding to a case that the unit cell is not being charged or discharged.

Further, it may be preferred that one of the two reference voltages is a first stabilization reference voltage including a first stabilization start voltage set to a value less than a maximum withstanding voltage of the unit cell and a first stabilization release voltage set to a value less than 97% of the first stabilization start voltage.

Further, in some cases, one of the two reference voltages may be determined as a first stabilization reference voltage including a first stabilization start voltage set to a value less than a value obtained by dividing a maximum allowable power voltage of a system using an energy storage as an energy source by the number of the unit cells and a first stabilization release voltage set to a value less than 97% of the first stabilization start voltage.

Further, it may be preferred that one of the two reference voltages is a second stabilization reference voltage including a second stabilization start voltage set to a range of 101 to 105% of an average value and a second stabilization release voltage set to a range of 95 to 99% of the average value, on the basis of the average value of the voltages of the unit cells.

Meanwhile, in accordance with another aspect of the present invention to achieve the object, there is provided a method for stabilizing a voltage of an energy storage formed by connecting a plurality of unit cells in series including: a) monitoring a voltage of the unit cell; b) determining whether the unit cell is being charged or discharged by using the monitored value; and c) stabilizing the voltage of the unit cell by applying two differently set reference voltages according to a result of determination in the step b).

At this time, it may be preferred that the step b) is configured to determine that the unit cell is not being charged or discharged if more than 5 seconds pass while the voltage of at least one unit cell is not changed by more than 10% on the basis of an average value of the voltages of the unit cells and in an opposite case to determine that the unit cell is being charged or discharged.

Further, the step b) may be configured to determine that the unit cell is being charged or discharged if the voltage of the unit cell is changed to a voltage corresponding to 50 to 100% of a maximum withstanding voltage of the unit cell for a time of less than 10 seconds and otherwise to determine that the unit cell is not being charged or discharged.

Meanwhile, it may be preferred that the step c) is performed in such a way to stabilize the voltage of the unit cell by distinguishing a first stabilization mode in which a first stabilization reference voltage is applied when the unit cell is being charged or discharged and a second stabilization mode in which a second stabilization reference voltage is applied when the unit cell is not being charged or discharged.

Further, it may be preferred that one of the two reference voltages is a first stabilization reference voltage including a first stabilization start voltage set to a value less than the maximum withstanding voltage of the unit cell and a first stabilization release voltage set to a value less than 97% of the first stabilization release voltage.

Further, in some cases, one of the two reference voltages may be determined as a first stabilization reference voltage including a first stabilization start voltage set to a value less than a value obtained by dividing a maximum allowable power voltage of a system using an energy storage as an energy source by the number of the unit cells and a first stabilization release voltage set to a value less than 97% of the first stabilization start voltage.

Further, it may be preferred that one of the two reference voltages is a second stabilization reference voltage including a second stabilization start voltage set to a range of 101 to 105% of an average value and a second stabilization release voltage set to a range of 95 to 99% of the average value, on the basis of the average value of the voltages of the unit cells.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing configuration in accordance with an embodiment of the present invention;

FIG. 2 is a flow chart showing configuration in accordance with an embodiment of the present invention;

FIG. 3 is a graph showing a first stabilization reference voltage in accordance with an embodiment of the present invention; and

FIG. 4 is a graph showing a second stabilization reference voltage in accordance with an embodiment of the present invention.

### DETAILED DESCRIPTION OF THE PREFERABLE EMBODIMENTS

Advantages and features of the present invention and methods of accomplishing the same will be apparent with reference to the following embodiments described in detail in conjunction with the accompanying drawings. However, the present invention is not limited to the following embodiments but may be embodied in various other forms. The embodiments are provided to complete the disclosure of the present invention and to completely inform a person with average knowledge in the art of the scope of the present invention. Like reference numerals refer to like elements throughout the specification.

Terms used herein are provided to explain embodiments, not limiting the present invention. Throughout this specification, the singular form includes the plural form unless the context clearly indicates otherwise. The terms “comprise” and/or “comprising” do not exclude the existence or addition of one or more different components, steps, operations, and/or elements.

Hereinafter, configuration and operation of the present invention will be described in detail with reference to the accompanying drawings.

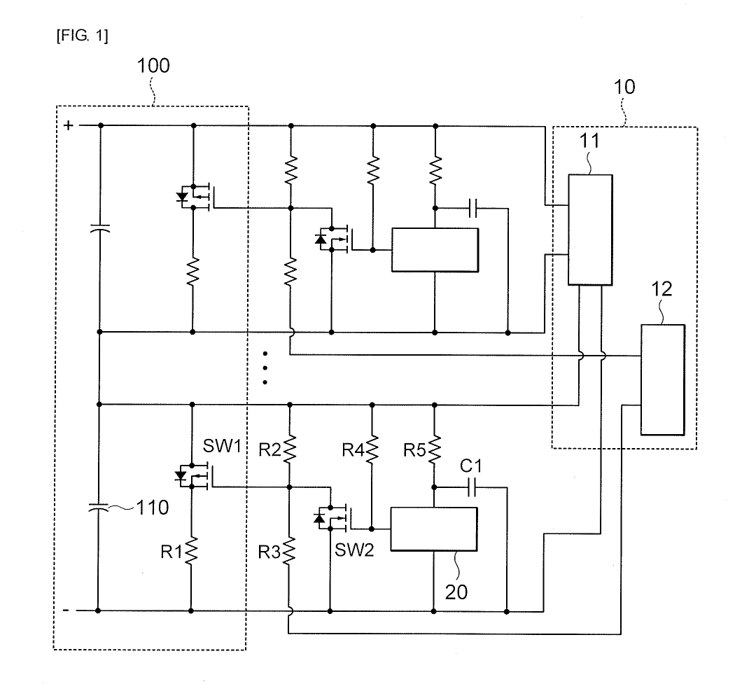

In order to obtain a high voltage, it is general to use a plurality of unit cells 110 by connecting the plurality of unit cells 110 in series as shown in FIG. 1.

A bypass unit and an analog circuit unit 20 are connected to each of the unit cells 110 in parallel, and both ends of all of the unit cells 110 are connected to a control unit 10.

Further, the bypass unit is controlled by being connected to the control unit 10 and the analog circuit unit 20.

The unit cell 110 may be a unit cell 110 of a secondary battery, a capacitor, and a supercapacitor (or ultracapacitor) or an energy storage showing similar characteristics.

The bypass unit is connected to each of the unit cell 110 in parallel and performs a function of bypassing a current flowing to the unit cell 110 to prevent an excessive current from being supplied to the unit cell 110.

At this time, as shown in FIG. 1, the bypass unit may be simply implemented by using a general bypass circuit in which a switch SW1 and a resistor R1 are connected in series.

When the switch is turned on, the current flowing to the unit cell 110 flows to the resistor so that a voltage of the unit cell 110 does not increase but decreases.

Meanwhile, it is obvious that a resistance value can be selected so as to perform bypassing according to characteristics of the unit cell 110.

Further, for convenience of description, the switch and the resistor, which constitute the bypass unit, are referred to as a first switch SW1 and a first resistor R1.

The control unit 10 detects and monitors the voltages of the unit cells 110 and reduces the voltage of the unit cell 110 of which a voltage level is higher than a predetermined level by generating a signal for operating the bypass unit when the detected voltage is higher than a reference voltage.

At this time, the control unit 10 may include a voltage detecting unit 11 for detecting the voltage of each of the unit cell 110 and a control signal generating unit 12 for generating a control signal transmitted to the bypass unit.

Further, the control unit 10 may include a storage means such as a memory for storing data such as the detected voltage and the reference voltage and a processor for performing various control commands and operations.

The analog circuit unit 20, like the bypass unit, also senses the voltage of the unit cell 110 by being connected to each of the unit cells 110 in parallel and performs a function of turning on the first switch SW1 by transmitting the signal to the bypass unit when a voltage higher than the reference voltage is applied to the unit cell 110.

The analog circuit unit 20 may be implemented by using a commonly used comparator, that is, an amplifier and so on.

However, the analog circuit unit 20, that is, a means for assisting the control unit 10 in stabilizing the voltages of the unit cells 110 in a software manner, is not an essential component of the present invention, and the scope of the present invention is not limited by FIG. 1.

Meanwhile, the control unit 10 performs a role of controlling on/off of the bypass unit by determining whether the unit cell 110 is being charged or discharged using the monitored voltage of the unit cell 110 and applying two differently set reference voltages.

At this time, a case that the unit cell 110 is being charged or discharged is referred to as a first stabilization mode, and a case that the unit cell 110 is not being charged or discharged is referred to as a second stabilization mode.

The first stabilization mode and the second stabilization mode perform voltage stabilization of the unit cells 110 by applying the two differently set reference voltages, for example, a first stabilization reference voltage and a second stabilization reference voltage.

Further, it is preferred that one of the two reference voltages is a first stabilization reference voltage including a first stabilization start voltage set to a value less than a maximum withstanding voltage of the unit cell 110 and a first stabilization release voltage set to a value less than 97% of the first stabilization start voltage.

Further, in some cases, one of the two reference voltages may be determined as a first stabilization reference voltage including a first stabilization start voltage set to a value less than a value obtained by dividing a maximum allowable power voltage of a system using an energy storage as an energy source by the number of the unit cells 110 and a first stabilization release voltage set to a value less than 97% of the first stabilization start voltage.

Further, it is preferred that the other of the two reference voltages is a second stabilization reference voltage including a second stabilization start voltage set to a range of 101 to 105% of an average value and a second stabilization release voltage set to a range of 95 to 99% of the average value, on the basis of the average value of the voltages of the unit cells 110.

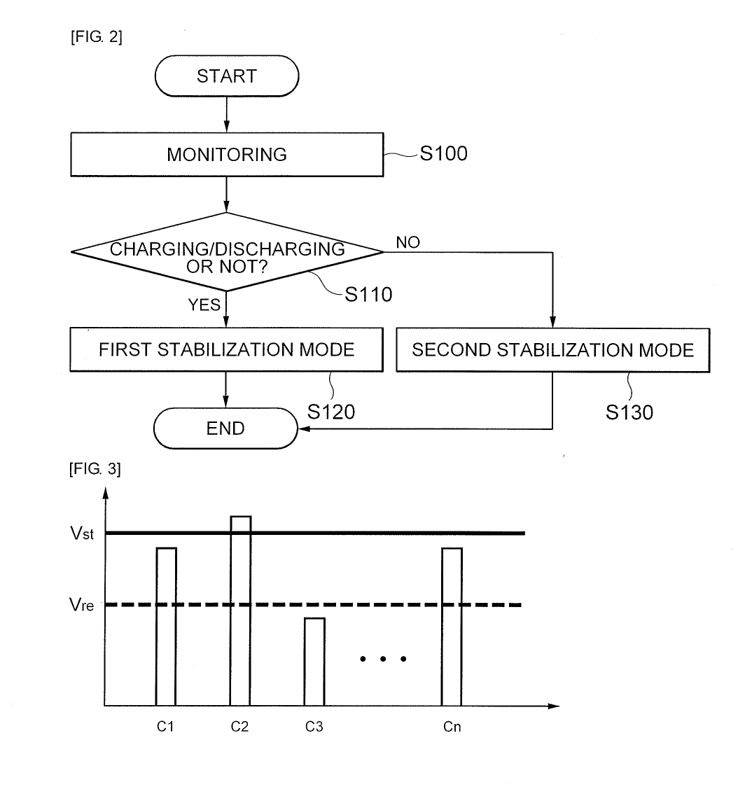

Hereinafter, a method for stabilizing a voltage of an energy storage in accordance with the present invention will be described in detail with reference to FIGS. 2 to 4.

FIG. 2 is a flow chart showing a method for stabilizing a voltage of an energy storage in accordance with the present invention.

As shown in the drawing, a method for stabilizing a voltage of an energy storage in accordance with the present invention may be configured to include the steps of a) monitoring (S100), b) determining whether charge or discharge operation is being performed (S110), and c) performing a first stabilization mode (S120) or a second stabilization mode (S130) according to a result of determination.

The step (S100) of monitoring may be performed in such a way to monitor a real-time change of voltages of both ends of a unit cell 100 through a sensor provided in a control unit 10, and it is equal to a conventional general method for stabilizing a voltage in a software manner.

The step (S110) of determining whether the charge or discharge operation is being performed, that is, a process of determining whether the unit cell 110 is being charged or discharged, may be performed in the following manner.

In general, in case that a supercapacitor cell is applied as the unit cell 110, the voltage of the unit cell 110 may be instantly rapidly changed during charge or discharge operation.

Considering this characteristic, in the method for stabilizing a voltage of an energy storage in accordance with an embodiment of the present invention, it is determined that the charge or discharge operation is not performed when the voltage of at least one of a plurality of unit cells 110 is not changed to a predetermined value for a predetermined time on the basis of an average voltage of the plurality of unit cells 110.

At this time, since the voltages of the unit cells 110 may be slightly changed even when the charge or discharge operation is not performed, it is preferable to determine on the basis of a specific range rather than a specific value. In the present invention, it is determined that a change within a range of 10% on the basis of the average voltage of the plurality of unit cells 110 is not a change due to the charge or discharge operation.

If an allowable range is set too large, a delay time after the charge or discharge operation is started until a voltage stabilization process is applied may occur, and overcharging of the unit cell 100 may occur due to this delay time.

Further, if the allowable range is set too small, there is no problem such as overcharging, but a degree of achieving the object of the present invention, that is, to secure efficiency of a voltage stabilization system may be reduced since precise voltage stabilization control can be performed even when the charge or discharge operation is not being performed.

At this time, the range may be slightly changed according to the number of the connected unit cells 110, operation voltages of the unit cells 110, and so on.

Meanwhile, in addition to the voltage change range, a duration time in which a constant voltage is maintained may be slightly changed according to charge and discharge characteristics of the unit cell 110 or the number of the connected unit cells 110. In the present invention, when the time in which the constant voltage is maintained is greater than five seconds, it is determined that the charge or discharge operation is not being performed.

If the time in which the constant voltage is maintained is set too short, although the charge or discharge operation is being performed, there is a concern that it is determined otherwise. If the time in which the constant voltage is maintained is set too long, the precise voltage stabilization control is unnecessarily continued for a long time to cause a reduction in the efficiency of the voltage stabilization system.

A voltage stabilization process is performed by applying different stabilization modes according to a result of determining whether the charge or discharge operation is being performed.

The stabilization modes may be classified into a first stabilization mode in which the stabilization process is performed by applying a first stabilization reference voltage when the unit cell 110 is being charged or discharged and a second stabilization mode in which the stabilization process is performed by applying a second stabilization reference voltage when the unit cell 110 is not being charged or discharged.

At this time, the first stabilization reference voltage may consist of a first stabilization start voltage and a first stabilization release voltage.

The first stabilization start voltage is applied as a start condition for starting the voltage stabilization process and bypassing a current of the unit cell 110 and may be set to a value less than a maximum withstanding voltage of the unit cell 110 which constitutes an energy storage.

Meanwhile, in various systems using the energy storage as an energy source, there may be an allowable range for a voltage supplied from the energy storage, and it is preferred that the first stabilization start voltage is set to a value less than a value obtained by dividing an allowable power voltage by the number of the unit cells 110 when the allowable power voltage is a value less than a total sum of the maximum withstanding voltages of the unit cells 110.

Further, the first stabilization release voltage may be set to a value less than 97% of the first stabilization start voltage.

The first stabilization start voltage becomes a reference for finishing bypassing. If the first stabilization start voltage is set too low, since a bypass duration time is excessively increased, the voltage of the unit cell 110 is excessively reduced to cause an increase in time required for completing charging when a charge process is in progress and an excessive current is instantly output when a discharge process is in progress.

Further, if the first stabilization start voltage is set too high, since bypassing is too quickly finished, deterioration of the unit cell 110 may occur due to excessive charging when the charging process is in progress.

Meanwhile, the second stabilization reference voltage is used as a reference for stabilizing the voltages of the unit cells 110 in a state in which the unit cells 110 are standing by in a stable state without being charged or discharged and may consist of a second stabilization start voltage and a second stabilization release voltage.

In the second stabilization mode to which the second stabilization reference voltage is applied, there is virtually no change in the voltages of the unit cells 110. However, stabilization operation is performed to prevent an unexpected excessive rise of the voltage of the specific unit cell 110.

Therefore, unlike the first stabilization mode, it is not necessary to precisely control the voltage of the unit cell 110 in the second stabilization mode.

Considering these facts, the second stabilization start voltage and the second stabilization release voltage may be set to maintain a predetermined deviation on the basis of the average voltage of the unit cells 110.

At this time, it is preferred that the second stabilization start voltage is set to a range of 101 to 105% of an average value and that the second stabilization release voltage is set to a range of 95 to 99% of the average value, on the basis of the average value of the voltages of the unit cells 110.

FIG. 3 shows a relation between the voltage of each unit cell and the first stabilization start voltage and the first stabilization release voltage at the time of performing the voltage stabilization according to the first stabilization mode.

At this time, as described above, the first stabilization start voltage Vst may be determined as a value less than the maximum withstanding voltage of the unit cell or the maximum allowable power voltage of the system using the energy storage as a power source, and the first stabilization release voltage Vre can be obtained by an equation 1.

$$Vre = Vst \times \frac{X}{100} \qquad 〈 Equation 1 〉$$

At this time, it is preferred that the X value is set to approximately 97 although it may be slightly changed in consideration of the number of the unit cells, the withstanding voltage of the unit cell, and so on.

Referring to FIG. 3, the voltage stabilization process is performed in such a way that stabilization starts so that C2 starts bypassing to cause a voltage drop since a cell voltage of C2 is higher than Vst and C3 finishes bypassing since a cell voltage of C3 is lower than Vre.

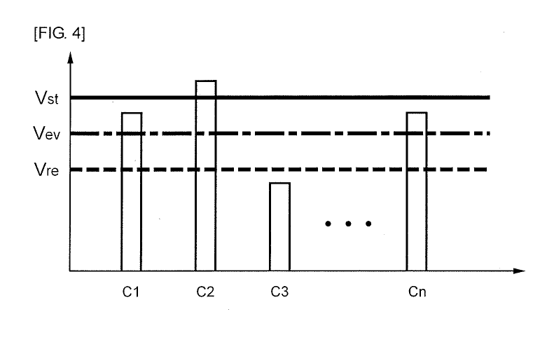

FIG. 4 shows a relation between the voltage of each unit cell and the second stabilization start voltage and the second stabilization release voltage at the time of performing the voltage stabilization according to the second stabilization mode.

At this time, the second stabilization start voltage and the second stabilization release voltage can be obtained by equations 2 and 3, respectively.

$$\begin{matrix}Vst = Vev ( 1 + \frac{Y}{100} ) & 〈 Equation 2 〉 \\ Vre = Vev ( 1 - \frac{Y}{100} ) & 〈 Equation 3 〉\end{matrix}$$

Vev represents the average voltage of the unit cells, and as described above, it is preferred that Y is a value of approximately 1 to 5.

Referring to FIG. 4, the voltage stabilization process is performed in such a way that stabilization starts so that C2 starts bypassing to cause a voltage drop since a cell voltage of C2 is higher than Vst and C3 finishes bypassing since a cell voltage of C3 is lower than Vre.

Through this voltage stabilization process, the voltage of the unit cell can be maintained as a constant value in a range approximate to the average value.

The present invention as configured above provides a useful effect that system resources consumed for voltage stabilization of an energy storage by precisely performing the voltage stabilization only during charging or discharging when an operation frequency and a voltage of the energy storage are suddenly displaced while performing the voltage stabilization with a relatively loose range in opposite case.

Further, the present invention provides useful effects that overload of a system for the voltage stabilization of the energy storage is prevented, power consumption is reduced, erroneous operation or stop of a module due to unbalance of a voltage of a unit cell is prevented, and a lifespan characteristic and reliability of the unit cell or the module are improved by reducing deterioration of the unit cell.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A device for stabilizing a voltage of an energy storage formed by connecting a plurality of unit cells in series comprising:
a bypass unit connected to the unit cell in parallel; and
a control unit connected to the unit cell in parallel to monitor a voltage of the unit cell and connected to the bypass unit to control on/off of the bypass unit, wherein the control unit controls the on/off of the bypass unit in two modes by determining whether the unit cell is being charged or discharged and applying two differently set reference voltages.

2. The device for stabilizing a voltage of an energy storage according to claim 1, wherein the two modes comprise:
a first stabilization mode corresponding to a case that the unit cell is being charged or discharged; and
a second stabilization mode corresponding to a case that the unit cell is not being charged or discharged.

3. The device for stabilizing a voltage of an energy storage according to claim 1, wherein one of the two reference voltages is a first stabilization reference voltage including a first stabilization start voltage set to a value less than a maximum withstanding voltage of the unit cell and a first stabilization release voltage set to a value less than 97% of the first stabilization start voltage.

4. The device for stabilizing a voltage of an energy storage according to claim 1, wherein one of the two reference voltages is a first stabilization reference voltage including a first stabilization start voltage set to a value less than a value obtained by dividing a maximum allowable power voltage of a system using an energy storage as an energy source by the number of the unit cells and a first stabilization release voltage set to a value less than 97% of the first stabilization start voltage.

5. The device for stabilizing a voltage of an energy storage according to claim 1, wherein one of the two reference voltages is a second stabilization reference voltage including a second stabilization start voltage set to a range of 101 to 105% of an average value and a second stabilization release voltage set to a range of 95 to 99% of the average value, on the basis of the average value of the voltages of the unit cells.

6. A method for stabilizing a voltage of an energy storage formed by connecting a plurality of unit cells in series comprising:
a) monitoring a voltage of the unit cell;
b) determining whether the unit cell is being charged or discharged by using the monitored value; and
c) stabilizing the voltage of the unit cell by applying two differently set reference voltages according to a result of determination in the step b).

7. The method for stabilizing a voltage of an energy storage according to claim 6, wherein the step b) determines that the unit cell is not being charged or discharged if more than 5 seconds pass while the voltage of at least one unit cell is not changed by more than 10% on the basis of an average value of the voltages of the unit cells and in an opposite case determines that the unit cell is being charged or discharged.

8. The method for stabilizing a voltage of an energy storage according to claim 6, wherein the step b) determines that the unit cell is being charged or discharged if the voltage of the unit cell is changed to a voltage corresponding to 50 to 100% of a maximum withstanding voltage of the unit cell for a time of less than 10 seconds and otherwise determines that the unit cell is not being charged or discharged.

9. The method for stabilizing a voltage of an energy storage according to claim 6, wherein the step c) stabilizes the voltage of the unit cell by distinguishing a first stabilizing mode in which a first stabilization reference voltage is applied when the unit cell is being charged or discharged and a second stabilization mode in which a second stabilization reference voltage is applied when the unit cell is not being charged or discharged.

10. The method for stabilizing a voltage of an energy storage according to claim 6, wherein one of the two reference voltages is a first stabilization reference voltage including a first stabilization start voltage set to a value less than the maximum withstanding voltage of the unit cell and a first stabilization release voltage set to a value less than 97% of the first stabilization start voltage.

11. The method for stabilizing a voltage of an energy storage according to claim 6, wherein one of the two reference voltages is a first stabilization reference voltage including a first stabilization start voltage set to a value less than a value obtained by dividing a maximum allowable power voltage of a system using an energy storage as an energy source by the number of the unit cells and a first stabilization release voltage set to a value less than 97% of the first stabilization start voltage.

12. The method for stabilizing a voltage of an energy storage according to claim 6, wherein one of the two reference voltages is a second stabilization reference voltage including a second stabilization start voltage set to a range of 101 to 105% of an average value and a second stabilization release voltage set to a range of 95 to 99% of the average value, on the basis of the average value of the voltages of the unit cells.
